(19) United States
(12) Patent Application Publication
(10) Pub. No.: US 2026/0109053 A1
(43) Pub. Date: Apr. 23, 2026

(54) GRIP UNIT AND VACUUM HANDLING APPARATUS COMPRISING SUCH A GRIP UNIT

(71) Applicant: J.Schmalz GmbH, Glatten (DE)

(72) Inventors: Valentin Stegmaier, Stuttgart (DE); Eva Klisch, Freudenstadt (DE); Christian Finkbeiner, Baiersbronn (DE); Fabian Urbschat, Baiersbronn (DE); Maurice Heyn, Eutingen (DE)

(73) Assignee: J. Schmalz GmbH, Glatten (DE)

(21) Appl. No.: 19/315,746

(22) Filed: Sep. 1, 2025

(30) Foreign Application Priority Data
Oct. 18, 2024 (DE) 10 2024 130 395.6

(51) Int. Cl. B25J 15/06

(52) U.S. Cl. CPC B25J 15/0616

(57) ABSTRACT

The invention relates to a grip unit (10) for use with a suction plate, comprising a housing (12) which has a grip portion (14), and a vacuum generating device (24), wherein the grip portion is designed as a hollow body, wherein exhaust air discharged by the vacuum generating device is guided through the grip portion to an air outlet (36), and a sound-damping device (46) is arranged in the grip portion. The invention also relates to a vacuum handling apparatus comprising such a grip unit and a suction plate.

The invention relates to a grip unit for a vacuum handling apparatus for laying, in particular, plate-shaped objects.

Such vacuum handling apparatuses, also referred to as vacuum hand-operated laying devices, are known from the prior art, for example from DE 10 2010 016 244 B4, DE 10 2017 119 554 A1 or WO 01/21357 A1. The known vacuum hand-operated laying devices usually comprise a suction plate for contact with an object to be gripped and a grip unit connected to the suction plate for holding the suction plate and an object sucked onto it. The grip unit can have an electrically operated vacuum pump to create a vacuum between the suction plate and the object and thus a holding force.

The known vacuum hand-operated laying devices are usually designed for suction against suction-tight workpieces such as glass panes or wooden boards.

The invention is concerned with the object of improving the operation of vacuum handling apparatuses of the type mentioned above and expanding the range of applications.

This object is achieved according to the invention by a grip unit having the features of claim 1. The grip unit is particularly designed for use with a suction plate for suction against an object.

The grip unit has a housing. The housing is designed in particular as a hollow body with a housing interior.

The housing has a grip portion, which in particular can be grasped one-handedly, for gripping the grip unit. The grip portion is designed in particular in such a way that an operator can grasp and preferably operate the grip unit via the grip portion.

The housing is designed as a hollow body, at least in the region of the grip portion. In this respect, the grip portion delimits an internal volume.

The grip unit has also has a vacuum generating device, in particular an electrically operated one. The vacuum generating device has in particular a suction inlet and an exhaust air outlet. The vacuum generating device is particularly designed to generate a vacuum between the suction plate and an object to be gripped when the grip unit is used with a suction plate.

The grip unit has an air outlet for discharging exhaust air from the vacuum generating device to an environment. Exhaust air discharged by the vacuum generating device is guided, in particular within the housing, in such a way that a flow path for the exhaust air leads from the vacuum generating device to an air outlet of the grip unit through the housing portion, i.e., through the volume enclosed by the housing. In other words, the grip unit has an air outlet and an exhaust air duct for guiding exhaust air from the vacuum generating device to the air outlet, wherein the exhaust air duct runs through the grip portion. In this respect, the grip portion (housing), in particular the inner volume delimited by the grip portion, forms part of an exhaust air duct for guiding exhaust air from the vacuum generating device to an air outlet of the grip unit.

A sound-damping device is arranged in the grip portion, i.e., in the volume enclosed by the housing in the region of the grip portion. In particular, a sound-damping material, in particular different from the material of the housing, is arranged in the grip portion. The sound-damping material can be part of a sound damper. In this respect a sound damper can be arranged in the grip portion. It is also conceivable that the grip portion is lined with a sound-damping material on the inside of its housing, at least in portions. Preferably, the sound-damping device forms a flow channel for the exhaust air between the vacuum generating device and the air outlet, and is therefore in particular part of the exhaust air duct for guiding exhaust air from the vacuum generating device to the air outlet.

Such a grip unit is convenient to operate and enables a wider range of applications than known vacuum hand-operated laying devices. For example, the proposed grip unit is comparatively quiet due to the integration of the sound-damping device into the grip unit, which reduces the requirements for necessary protective measures such as hearing protection and has a positive effect on working comfort even during longer periods of operation. In addition, the use of vacuum generating devices is enabled, which enable high volume flows but have not been used until now for noise protection reasons. For example, a blower can be used as a vacuum generating device and enables reliable suction even of porous workpieces. Because the sound-damping device is integrated into the existing grip portion (and not outside the housing, for example), any interference contour when gripping is minimized, which is crucial for ease of use in a hand-held device. In addition, the comparatively long flow path through the grip portion achieves efficient sound damping.

Preferably, sound damping includes preventing sound propagation by absorbing airborne sound. In this respect, the sound-damping device, in particular the sound-damping material, can be designed to absorb airborne sound.

The sound-damping material can be, for example, a foam material, in particular melamine resin foam or composite foam.

The grip unit is preferably designed to be carried one-handedly.

The housing can be composed of two or more shells. The housing preferably has one or more suction openings and one or more exhaust air openings. The at least one suction opening is in particular fluidically connected to the suction inlet of the vacuum generating device. The at least one exhaust air opening can then form the air outlet of the grip unit. The at least one exhaust air opening is in particular fluidically connected to the exhaust air outlet of the vacuum generating device, in particular via the above-mentioned exhaust air duct.

The grip portion is preferably elongate. The grip portion can be cylindrical. The grip portion can have a round, oval, square or irregular cross-section. The grip portion can have a constant diameter. The grip portion can have a diameter that varies along the longitudinal direction. For example, the grip portion can be bulbous.

The vacuum generating device is preferably electrically operated. The vacuum generating device can have a vacuum pump. Preferably, the vacuum generating device comprises a blower.

It proves advantageous if the vacuum generating device is arranged, in particular completely, in a first housing portion of the housing. In this way, a particularly compact design with minimal interference contours is achieved. In addition, defined exhaust air routing is facilitated in order to reduce noise pollution on the one hand (see above) and on the other hand to prevent an operator from being directly exposed to the exhaust air. Finally, by accommodating the vacuum generating device in the housing, the emission of operating noise from the vacuum generating device to the outside is reduced, which has a further positive effect on noise pollution and thus further improves operation.

Furthermore, it proves to be advantageous if a sound-reducing device is arranged in the first housing portion. In particular, a sound-reducing material, in particular different from the material of the housing, is arranged in the first housing portion. For example, the first housing portion can be lined with a sound-reducing material. The sound-reducing device, in particular the sound-reducing material, is designed in particular to reduce or substantially prevent sound propagation through the first housing portion to the outside. In an embodiment with a sound-reducing device, noise pollution caused by operating noise emanating from the vacuum generating device can be further reduced, which, for example, further promotes the above-mentioned use of comparatively loud but powerful blowers and thus expands the range of applications of the vacuum handling apparatus.

The sound-reducing device can be designed differently. In an advantageous implementation, the sound-reducing device can be a sound-damping device. In particular, the sound-reducing device can be designed to prevent the propagation of airborne sound and preferably also of structure-borne sound. In particular, the sound-reducing material can be a sound-damping material, e.g. a foam composite material.

A combination of a sound-damping device, in particular a sound-damping material, in the first housing portion and a sound-damping device, in particular a sound-damping material, in the grip portion has proven to be particularly advantageous. In this way, the overall noise pollution could be significantly reduced.

In an advantageous development, the grip portion extends longitudinally between a first (front) housing portion, in which the vacuum generating device is arranged, and a second (rear) housing portion, on which the air outlet is arranged. The air outlet and the vacuum generating device are arranged on opposite sides with respect to the grip portion. In this way the comparatively ‘long’ path through the grip portion can be used to absorb sound, resulting in efficient noise reduction. A further advantageous aspect of such a design is the possibility of directing the exhaust air backwards and thus away from the face of an operator.

Furthermore, it may be advantageous if the exhaust air discharged by the vacuum generating device is first collected and in particular directed before it is discharged via the grip portion. In this way, pressure losses can be reduced. In an advantageous implementation, the grip unit can have an air collection device, in particular in the form of an air collection screw, for collecting and in particular directing the exhaust air discharged by the vacuum generating device. The air collection device is provided in particular upstream of the grip portion. In this respect, the air collection device can be designed in particular to collect and in particular direct exhaust air before it is passed on to the grip portion. The air collection device is arranged in particular in the first housing portion. The air collection device is in particular spiral-shaped. The air collection device can have one or more air baffles for diverting and/or redirecting the exhaust air.

Furthermore, it can prove advantageous if the grip unit, downstream of the grip portion, in particular on or in the second housing portion, has one or more air baffles (diverting plates) for directing the exhaust air. The at least one air baffle can be arranged in particular in a flow path between the grip portion and the air outlet. The at least one air baffle is preferably designed to reduce pressure losses. In particular, the at least one air baffle is bent or curved. Such an embodiment makes it possible to direct exhaust air emerging from the grip portion towards the air outlet with as little deflection as possible and with a maximum cross-section.

Furthermore, it can prove advantageous if one or more air baffles are provided in the region of the air outlet or downstream of the air outlet, for example on the outside of the housing, to direct the exhaust air emitted from the air outlet. The air baffles can in particular be designed in such a way that exhaust air emerging from the air outlet is directed away from an operator. In this way, operating comfort is increased, as air is not blown directly at the operator. In addition, protective requirements, such as face protection, can be reduced.

As mentioned above, the vacuum generating device can in particular be electrically operated. In order to supply the vacuum generating device with operating energy, the grip unit can have a battery coupling point on the housing for coupling an electrical energy storage device, in particular a rechargeable battery. Preferably, the battery coupling point is arranged on the second housing portion. It is particularly advantageous if the vacuum generating device is arranged in the first housing portion and the battery coupling point is arranged on the second housing portion, i.e., opposite each other with respect to the grip portion. In this way, a particularly advantageous weight distribution is achieved, which makes handling the grip unit easier.

In an embodiment with a battery coupling point, it can be particularly advantageous if one or more air baffles are provided in the region of the air outlet or downstream of the air outlet, for example on the outside of the housing, to divert the exhaust air away from the battery coupling point. In this respect, air baffles can be provided which are designed in such a way that air emerging from the air outlet is redirected away in the direction of the battery coupling point. In this way, it can be prevented that potentially warm exhaust air flows around the energy storage unit, thus heating it up and possibly damaging it.

Within the scope of a general aspect, the grip unit can have a coupling device, in particular a quick-change device, for the releasable coupling of a suction plate. The coupling device is designed in particular such that, in the connected state of the grip unit and the suction plate, a fluidic connection is established between the vacuum generating device, in particular the suction opening of the housing, and a suction chamber delimited by the suction plate and in particular by a held object.

Independently of the advantageous embodiments described above, the grip unit can have further optional functional units. For example, the grip unit can have a valve device for controlling flow connections, e.g., for controlling a fluidic connection between the vacuum generating device and the suction opening. The grip unit can have an operating unit for controlling the vacuum generating device. The control unit can, for example, comprise one or more switches, a display and/or a control unit.

As part of a general aspect, a grip unit for a vacuum hand-operated laying device, in particular for use with a suction plate, is proposed, comprising
a housing which has a grip portion, which in particular can be grasped one-handedly, for gripping the grip unit, and
a vacuum generating device arranged in a first housing portion of the housing,
   wherein a sound-reducing, in particular sound-damping, device is arranged in the first housing portion. The advantages and optional features described above can also be used to design this grip unit.

The object described above is also achieved by a vacuum handling apparatus, comprising
a suction plate and
a grip unit, in particular releasably connected to the suction plate, wherein the grip unit comprises a housing and an, in particular electrically operated, vacuum generating device, in particular a blower, for generating a vacuum between the suction plate and an object to be gripped,
wherein the housing has a grip portion, which in particular can be grasped one-handedly, for gripping the grip unit (and thus for handling an object arranged on the suction plate),
wherein the grip portion is designed as a hollow body, wherein exhaust air discharged by the vacuum generating device is guided through the grip portion to an air outlet, and wherein a sound-damping device is arranged in the grip portion, in particular the grip portion is lined on its inside with sound-damping material.

The advantages and optional features described above with respect to the grip unit can also be used to design the vacuum handling apparatus so that reference is made to the above disclosure in this respect in order to avoid repetitions.

The vacuum handling apparatus is in particular a vacuum hand-operated laying device for handling preferably plate-shaped objects.

The suction plate can have a carrier plate and a seal, which is fastened to the carrier plate and preferably extends around it, for example in the form of a sealing element.

Preferably, the grip unit, in particular in the housing, has a suction opening which is in fluidic connection with a suction chamber delimited by the suction plate in order to generate a vacuum between the suction plate and an object to be lifted.

The invention is explained in more detail below with reference to the figures. In the drawings:

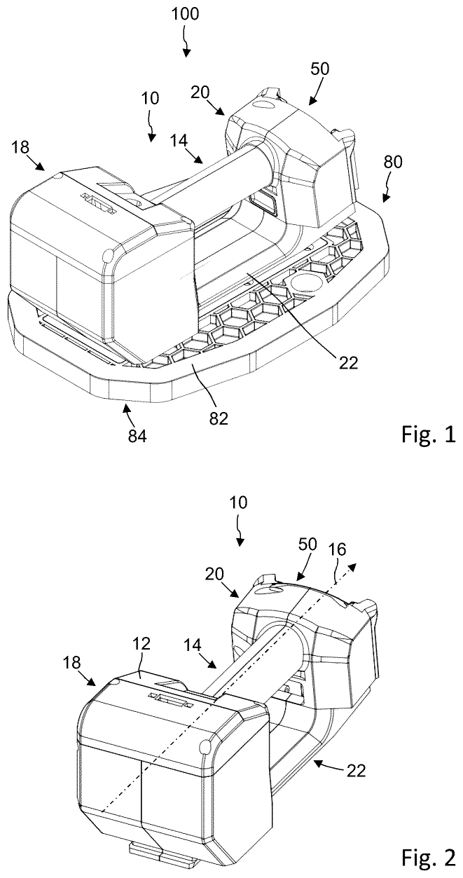

FIG. 1 shows a sketched representation of an exemplary embodiment of a vacuum handling apparatus comprising a grip unit and a suction plate in a perspective view;

FIG. 2 shows the grip unit according to FIG. 1 in a perspective view;

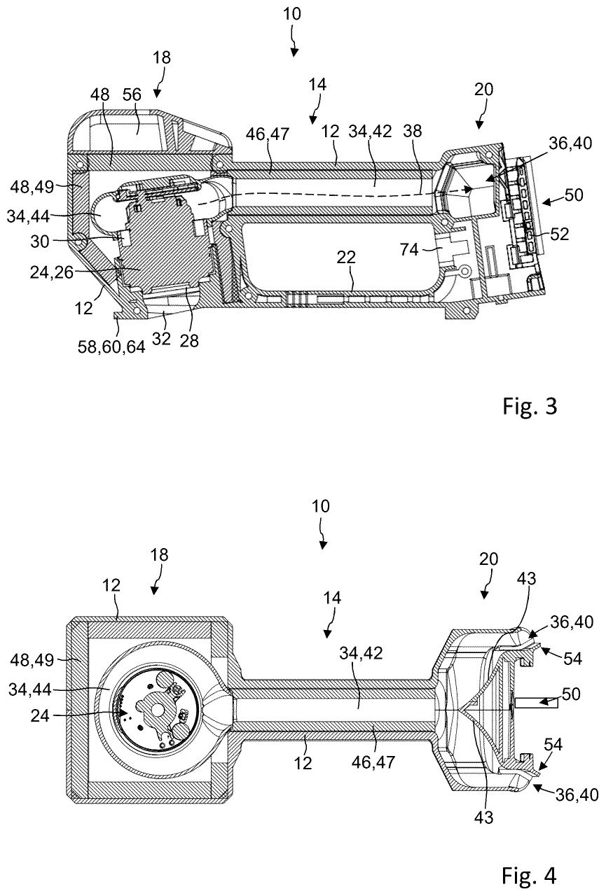

FIG. 3 shows the grip unit according to FIG. 2 in a first sectional view;

FIG. 4 shows the grip unit according to FIG. 2 in a second sectional view;

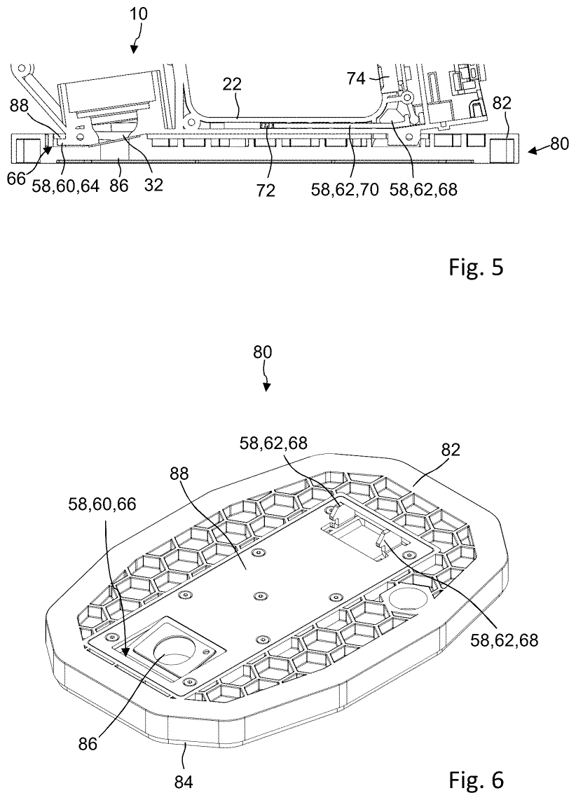

FIG. 5 shows a detail of the vacuum handling apparatus according to FIG. 1 in a further sectional view to explain an embodiment of the coupling device; and

FIG. 6 shows the suction plate of the vacuum handling apparatus according to FIG. 1 in a perspective view.

In the following description and in the figures, identical reference signs are in each case used for identical or corresponding features.

FIG. 1 shows, in a sketched representation, an exemplary embodiment of a vacuum handling apparatus which is denoted as a whole by reference sign 100. The vacuum handling apparatus 100 is designed as a vacuum hand-operated laying device for laying, in particular, plate-shaped objects.

The vacuum handling apparatus 100 has a grip unit 10 and a suction plate 80. The grip unit 10 and the suction plate 80 are preferably releasably connected to one another by means of a coupling device 58.

In the example, the suction plate 80 comprises a carrier plate 82 and a seal 84 which is fastened to the carrier plate 82 and extends around the latter and by means of which the suction plate 80 is placed onto an object to be gripped. When placed, a suction chamber is then sealed between the suction plate 80 and the object, via which chamber the object can be suctioned and thus held.

The grip unit 10 has a housing 12. The housing 12 has a grip portion 14 which, in the example, can be grasped one-handedly. The grip portion 14 extends along a longitudinal direction 16 between a first, front housing portion 18 and a second, rear housing portion 20.

In the example, the first housing portion 18 and the second housing portion 20 are also connected to each other by a base portion 22 of the housing 12. As can be seen from FIG. 1, the grip unit 10 with the base portion 22 is placed on the carrier plate 82 of the suction plate 80 and connected via the coupling device 58.

As can be seen from FIG. 3, the housing 12 is designed as a hollow body. For example, the housing 12 can be composed of two or more shells.

The grip unit 12 has a vacuum generating device 24, which in the example is designed as a blower 26. In embodiments not shown, the vacuum generating device 24 can also be designed differently, for example in the form of a pump.

The vacuum generating device 24 is accommodated in the first housing portion 18. The vacuum generating device 24 has a suction inlet 28 and an exhaust air outlet 30.

As can be seen from FIG. 3, the suction inlet 28 is fluidically connected to a suction opening 32 of the housing 12, so that air can be sucked in through the suction opening 32 during operation. In the assembled state of the grip unit 10 and the suction plate 80, the suction opening 32 is then in fluidic connection via a through-opening 86 in the carrier plate 82 with the suction chamber sealed between the suction plate 80 and the object to be gripped.

The exhaust air outlet 30 is fluidically connected to an air outlet 36 of the grip unit 10 via an exhaust air duct 34 (flow channel) in order to discharge exhaust air discharged by the vacuum generating device 24 from the housing 12 (an exhaust air flow path is indicated in FIG. 3 by way of example by the arrow line provided with reference sign 38).

In the example, the air outlet 36 is formed by two exhaust air openings 40 in the second housing portion 18. In embodiments not shown, the air outlet 36 can also be provided by more or fewer exhaust air openings 40.

As can be seen from FIGS. 3 and 4, the exhaust air duct 34 runs through the grip portion 14 of the housing 12. A housing interior 42 delimited by the grip portion 14 thus forms part of the exhaust air duct 34.

In the example shown, the exhaust air duct 34 also has one or more air baffles 43 downstream of the grip portion 14 for directing exhaust air exiting from the grip portion 14 to the air outlet 36. For example, an air baffle is provided for each exhaust air opening 40. As shown in FIG. 4, the air baffles 43 are preferably curved.

In the example shown, the exhaust air duct 34 also has an air collection device 44 arranged upstream of the grip portion 14. The air collection device 44 is fluidically connected to the exhaust air outlet 30 of the vacuum generating device 24 and is configured to collect exhaust air discharged by the vacuum generating device 24 and to supply it in a collected manner to the grip portion 14 (for passing on to the air outlet 36).

As mentioned above, a sound-damping device 46 is arranged in the grip portion 14. In the example, the sound-damping device 46 is formed by lining the grip portion 14 on its inside with sound-damping material 47. The sound-damping device 46 defines the exhaust air duct 34 in the grip portion 12.

In the example shown, a sound-reducing, preferably sound-damping, device 48 is also arranged in the first housing portion 18. Specifically, the first housing portion 18 is lined with a sound-reducing, preferably sound-damping, material 49.

The vacuum generating device 24 is preferably electrically operated. In particular the vacuum handling apparatus 100 can be rechargeable or battery-operated. For this purpose, the grip unit 10 in the example has a battery coupling point 50 for the releasable coupling of an electrical energy storage device, in particular a rechargeable battery (not shown). The battery coupling point 50 is, by way of example and preferably, arranged on an end face of the second housing portion 20.

As can be seen from FIG. 3, the battery coupling point 50 has several electrical contacts 52. Electrical connecting cables (not shown) between the electrical contacts 52 and the vacuum generating device 24 can in particular run through the base portion 22 or through the grip portion 14.

As can be seen from FIG. 4, optional air baffles 54 are provided at the exhaust air openings 40 and are designed in such a way that exhaust air emerging from the exhaust air openings 40 is directed away from the battery coupling point 50 and thus is diverted away from a rechargeable battery contained therein.

The grip unit 10 can optionally have an operating unit (not shown) for controlling the vacuum generating device 24. The control unit can, for example, comprise one or more switches, a display and/or a control unit. The operating unit can be arranged, for example, in the first housing portion 18, e.g., in the housing space designated by reference sign 56 in FIG. 3.

As mentioned above, the grip unit 10 and the suction plate 80 are preferably releasably connected to one another via a coupling device 58, in particular in the form of a quick-change device.

In the specific example, the coupling device 58 has a first connecting device 60, which is effective between the first housing portion 18 and the suction plate 80, and a second connecting device 62, which is effective between the second housing portion 20 and the suction plate 80 (see FIG. 5).

The first connecting device 60 is designed, for example, as a form-fitting connection. Specifically, the first connecting device 60 has an insertion portion 64 (see FIGS. 3 and 5), arranged in the example on the grip unit 10, and a receiving portion 66 (see FIG. 5), arranged in the example on the suction plate 80, for receiving the insertion portion 64. In the example, the insertion portion 64 is formed by a housing projection on the first housing portion 18. In the example, the receiving portion 66 is formed between the carrier plate 82 and a coupling plate 88 connected to the carrier plate 82 (see FIGS. 5 and 6).

The second connecting device 62 is designed as a locking device. Specifically, the second connecting device 62 comprises one or more, in the example two, locking elements 68, which are arranged on the suction plate 80, and at least one counter-locking element 70, which is arranged on the grip unit 10 (cf. FIG. 5).

In the exemplary embodiment, the locking elements 68 are designed as locking hooks which protrude from the suction plate 80, in the example from the coupling plate 88. The counter-locking element 70 is arranged in the housing 12 of the grip unit 10. The counter-locking element 70 can, for example, be designed as a locking plate which can be moved between a locking position and a release position. In the example, the counter-locking element 70 is biased, e.g. spring-loaded, into the locking position by means of a spring device 72.

To couple the suction plate 80 to the grip unit 10 or the grip unit 10 to the suction plate 80, the grip unit 12 is in particular first placed in a position oblique to the suction plate 80 and the insertion portion 64 is inserted into the receiving portion 66, i.e., the first connecting device 60 is activated. The grip unit 10 is then pivoted towards the suction plate 80 so that the second housing portion 20 moves towards the suction plate 80 and the locking connection (second connecting device 62) is thereby established.

The second connecting device 62 (locking device) can be released again in particular via an operating element 74 arranged on the grip unit 10, for example in the form of a push button. In particular, the operating element 72 can mechanically interact with the counter-locking element 70 in such a way that when the operating element 74 is actuated, the counter-locking element 70 is moved from the locking position into the release position.

1. A grip unit for a vacuum hand-operated laying device and for use with a suction plate, the grip unit comprising:
a housing which has a grip portion for gripping the grip unit, and
an, electrically operated, vacuum generating device, wherein
the grip portion is designed as a hollow body,
exhaust air discharged by the vacuum generating device is guided through the grip portion to an air outlet, and
a sound-damping device is arranged in the grip portion.

2. The grip unit according to claim 1, wherein the grip portion is at least partially lined with a sound-damping material.

3. The grip unit according to claim 1, wherein the vacuum generating device is arranged completely in a first housing portion of the housing.

4. The grip unit according to claim 3, wherein a sound-reducing device is arranged in the first housing portion or the first housing portion is lined with sound-reducing material.

5. The grip unit according to claim 3, wherein the grip portion is elongated between the first housing portion and a second housing portion, wherein the air outlet is arranged on the second housing portion.

6. The grip unit according to claim 3, further comprising an air collection device, in the form of an air collection screw, arranged upstream of the grip portion, in the first housing portion, for collecting the exhaust air before passing the exhaust air on to the grip portion.

7. The grip unit according to claim 1, wherein downstream of the grip portion, in on or in the second housing portion, one or more, bent or curved, air baffles are arranged for guiding exhaust air emerging from the grip portion to the air outlet.

8. The grip unit according to claim 1, wherein a battery coupling point for coupling an electrical energy storage device or a rechargeable battery is arranged on the housing, on the second housing portion, wherein one or more air baffles for directing the exhaust air away from the battery coupling point are provided in an region of the air outlet or downstream of the air outlet.

9. A vacuum handling apparatus comprising
said suction plate comprising a carrier plate and a seal, which is fastened to the carrier plate and extends around the carrier plate; and
said grip unit according to claim 1.

10. The vacuum handling apparatus according to claim 9, wherein the grip unit and the suction plate are releasably connected to one another via a coupling device.

11. The vacuum handling apparatus according to claim 9, wherein the grip unit has a suction opening, which is fluidically connected to a suction chamber delimited by the suction plate in order to generate a vacuum between the suction plate and an object to be lifted.
